(19) United States
(12) Patent Application Publication
(10) Pub. No.: US 2019/0206027 A1
(43) Pub. Date: Jul. 4, 2019

(54) DISPLAY CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventors: Shinichi Uemura, Kawasaki-shi (JP); Eisaku Tatsumi, Kawasaki-shi (JP)

(21) Appl. No.: 16/232,501

(22) Filed: Dec. 26, 2018

(30) Foreign Application Priority Data
Dec. 28, 2017 (JP) 2017-254398

(51) Int. Cl. G06T 3/40; G06T 5/00; G09G 3/00

(52) U.S. Cl. CPC G06T 3/4076; G06T 5/009; G09G 3/001; G09G 2320/0673; G06T 2207/20208; G09G 2340/0407; G09G 2320/066; G06T 2207/20221

(57) ABSTRACT

A display control apparatus obtains a first image in which an input image is represented at a first resolution and inverse gamma converted, and a second image representing the input image at a second resolution lower than the first resolution. The apparatus converts the second image into a third image for which: an inverse gamma conversion is performed; change in tone of each pixel is the same as in the second image; and resolution is represented by the first resolution. The apparatus outputs, for a stack projection, the second image and a corrected image which is obtained by correcting each pixel of the first image based on a difference between a pixel value of each pixel of the first image and a pixel value of each pixel of the third image and applying a gamma correction, and the second image.

### BACKGROUND OF THE INVENTION

### Field of the Invention

The present invention relates to a technique of projecting a plurality of images to overlap each other on a projected surface.

### Description of the Related Art

In general, there is known a multi-projection system (stack projection) of displaying, on a projected surface, a plurality of identical images from a plurality of projectors to overlap each other. It is common to use projectors of the same resolution in this system. However, if high-resolution stack projection is required, a plurality of high-end projectors are necessary, thereby increasing the cost.

To reduce the cost, Japanese Patent Laid-Open No. 2014-178393 (to be referred to as literature 1 hereinafter) discloses a method of performing projection using projectors of different resolutions. In this method, a high-end high-resolution projector and a low-end low-resolution projector can be used to perform stack projection by matching the sizes of the pixels of the two projectors with each other by resolution conversion.

In the technique disclosed in literature 1, however, there is a problem that the rough pixels of the low-resolution projector overlap the fine pixels of the high-resolution projector, and it is thus impossible to obtain a high resolution.

### SUMMARY OF THE INVENTION

According to one aspect of the present invention, there is provided a display control apparatus for controlling stack projection by a plurality of projection apparatuses including a first projection apparatus configured to project an image at a first resolution and a second projection apparatus configured to project an image at a second resolution lower than the first resolution, comprising: an obtaining unit configured to obtain a first image obtained by representing a projection target input image at the first resolution and performing inverse gamma conversion and a second image obtained by representing the input image at the second resolution; a converting unit configured to convert the second image represented at the second resolution into a third image for which inverse gamma conversion has been performed, for which change in tone of each pixel is the same as in the second image, and for which resolution is represented by the first resolution; an image correction unit configured to correct a pixel value of each pixel of the first image based on a difference between the pixel value of each pixel of the first image and a pixel value of each pixel of the third image; a first gamma correction unit configured to perform gamma correction for a corrected image output from the image correction unit; and an output unit configured to output the corrected image corrected by the first gamma correction unit and the second image to the first projection apparatus and the second projection apparatus, respectively.

According to another aspect of the present invention, there is provided a control method for a display control apparatus for controlling stack projection by a plurality of projection apparatuses including a first projection apparatus configured to project an image at a first resolution and a second projection apparatus configured to project an image at a second resolution lower than the first resolution, the method comprising: obtaining a first image obtained by representing a projection target input image at the first resolution and performing inverse gamma conversion and a second image obtained by representing the input image at the second resolution; converting the second image represented at the second resolution into a third image for which an inverse gamma conversion is performed, for which change in tone of each pixel is the same as in the second image, and for which resolution is represented by the first resolution; obtaining a corrected image by correcting a pixel value of each pixel of the first image based on a difference between the pixel value of each pixel of the first image and a pixel value of each pixel of the third image; performing gamma correction for the corrected image; and outputting the corrected image having undergone the gamma correction and the second image to the first projection apparatus and the second projection apparatus, respectively.

According to another aspect of the present invention, there is provided a non-transitory computer-readable storage medium storing a program for causing a computer to execute a control method for a display control apparatus for controlling stack projection by a plurality of projection apparatuses including a first projection apparatus configured to project an image at a first resolution and a second projection apparatus configured to project an image at a second resolution lower than the first resolution, the method comprising: obtaining a first image obtained by representing a projection target input image at the first resolution and performing inverse gamma conversion and a second image obtained by representing the input image at the second resolution; converting the second image represented at the second resolution into a third image for which an inverse gamma conversion is performed, for which change in tone of each pixel is the same as in the second image, and for which resolution is represented by the first resolution; obtaining a corrected image by correcting a pixel value of each pixel of the first image based on a difference between the pixel value of each pixel of the first image and a pixel value of each pixel of the third image; performing gamma correction for the corrected image; and outputting the corrected image having undergone the gamma correction and the second image to the first projection apparatus and the second projection apparatus, respectively.

Further features of the present invention will become apparent from the following description of exemplary embodiments with reference to the attached drawings.

### BRIEF DESCRIPTION OF THE DRAWINGS

FIG. 1 is a view showing an example of the schematic arrangement of an image projection system 11 according to the first embodiments;

FIG. 2 shows views for explaining processing for stack projection according to the first embodiment;

FIG. 3 shows schematic views when typical stack projection is performed;

FIG. 4 shows schematic views when stack projection is performed according to the first embodiment;

FIG. 5 is a block diagram showing an example of the hardware arrangement of a display control apparatus 20;

FIG. 6 is a flowchart illustrating processing of the display control apparatus 20 according to the first embodiment;

FIG. 7 is a view showing an example of the schematic arrangement of an image projection system 12 according to the second embodiment;

FIG. 8 shows views for explaining a difference in stack projection between the first and second embodiments;

FIG. 9 is a graph showing gamma characteristics;

FIG. 10 is a flowchart illustrating processing of a display control apparatus 22 according to the second embodiment;

FIG. 11 is a view showing an example of the schematic arrangement of an image projection system 13 according to the third embodiment;

FIG. 12 shows views for explaining processing for stack projection according to the third embodiment;

FIG. 13 is flowchart illustrating processing of a display control apparatus 24 according to the third embodiment;

FIG. 14 is a view showing an example of the schematic arrangement of an image projection system 14 according to the fourth embodiment;

FIG. 15 shows views for explaining processing for stack projection according to the fourth embodiment;

FIG. 16 shows schematic views when typical stack projection is performed;

FIG. 17 shows schematic views when stack projection is performed according to the fourth embodiment; and

FIG. 18 is a flowchart illustrating processing of a display control apparatus 26 according to the fourth embodiment.

### DESCRIPTION OF THE EMBODIMENTS

Embodiments of the present invention will be described in detail below with reference to the accompanying drawings. Note that arrangements to be described in the following embodiments are merely examples, and the present invention is not limited to the illustrated arrangements. In addition, throughout the accompanying drawings for explaining the embodiments, the same reference numerals denote the same components and a repetitive description thereof will be omitted.

### First Embodiment

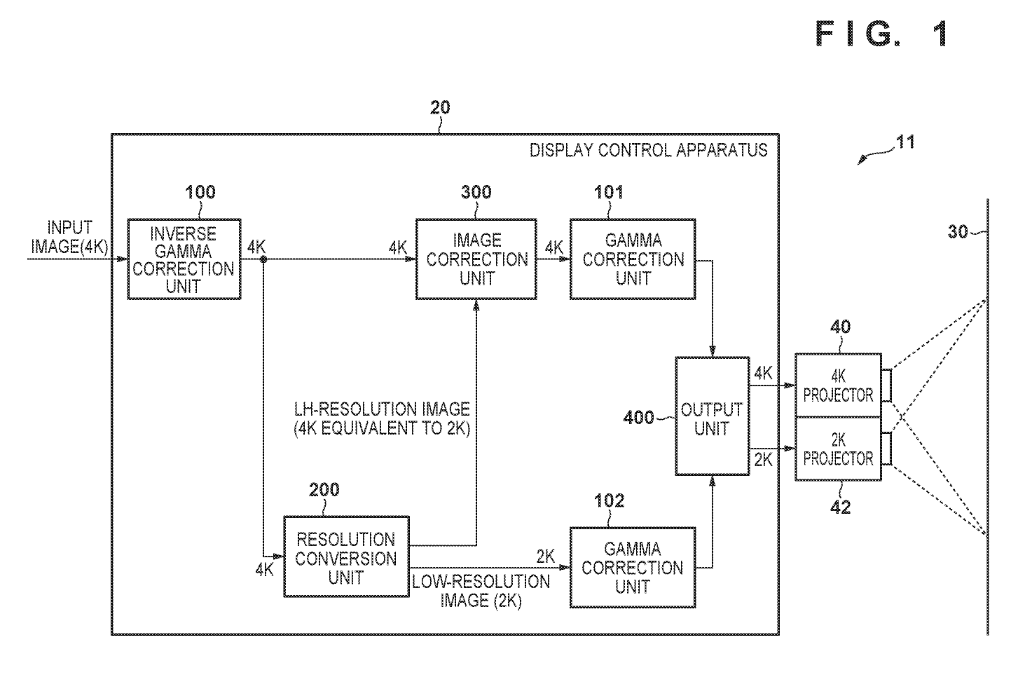

FIG. 1 is a view showing an example of the schematic arrangement of an image projection system 11 according to the first embodiment. The image projection system 11 includes a display control apparatus 20 and projectors 40 and 42. A high-resolution (4K) image is input to the display control apparatus 20, undergoes resolution conversion, image correction, and the like, and is then output to the 4K projector 40 and the 2K projector 42. The projectors 40 and 42 are examples of the first and second projection apparatuses of different resolutions, and projection target images are projected to overlap each other on a screen 30 (to be referred to as stack projection hereinafter). In the first embodiment, examples of the low- and high-resolution projectors will be described using a combination of 2K and 4K resolutions. However, a combination of resolutions of projectors is not limited to this, and the ratio is not limited to a ratio of 1:2.

The display control apparatus 20 is, for example, an information processing apparatus such as a PC (Personal Computer), and includes an inverse gamma correction unit 100, gamma correction units 101 and 102, a resolution conversion unit 200, an image correction unit 300, and an output unit 400.

The inverse gamma correction unit 100 performs inverse gamma correction for the 4K input image. The resolution conversion unit 200 generates, from the input image, an image (to be referred to as an LH-resolution image hereinafter) whose change in tone of each pixel is 2K and whose resolution is 4K. In addition, the resolution conversion unit 200 generates a 2K low-resolution image by reducing the resolution of the 4K input image.

The image correction unit 300 obtains the LH-resolution image generated by the resolution conversion unit 200 and the 4K input image corrected by the inverse gamma correction unit 100. Then, the image correction unit 300 corrects the 4K input image using the differences between the pixel values of the images as correction values, thereby generating a high-resolution corrected image.

The gamma correction unit 101 performs gamma correction for the high-resolution corrected image corrected by the image correction unit 300, and sends the thus obtained image to the output unit 400. The gamma correction unit 102 performs gamma correction for the low-resolution image generated by the resolution conversion unit 200, and sends the thus obtained image to the output unit 400.

The output unit 400 outputs the high-resolution corrected image having undergone gamma correction to the 4K projector 40, and outputs the low-resolution image having undergone gamma correction to the 2K projector 42.

Referring to FIG. 1, the 4K input image is an example of the first image represented at the first resolution, the 2K low-resolution image is an example of the second image represented at the second resolution, and the LH-resolution image obtained by converting the low-resolution image into an image of the first resolution is an example of the third image.

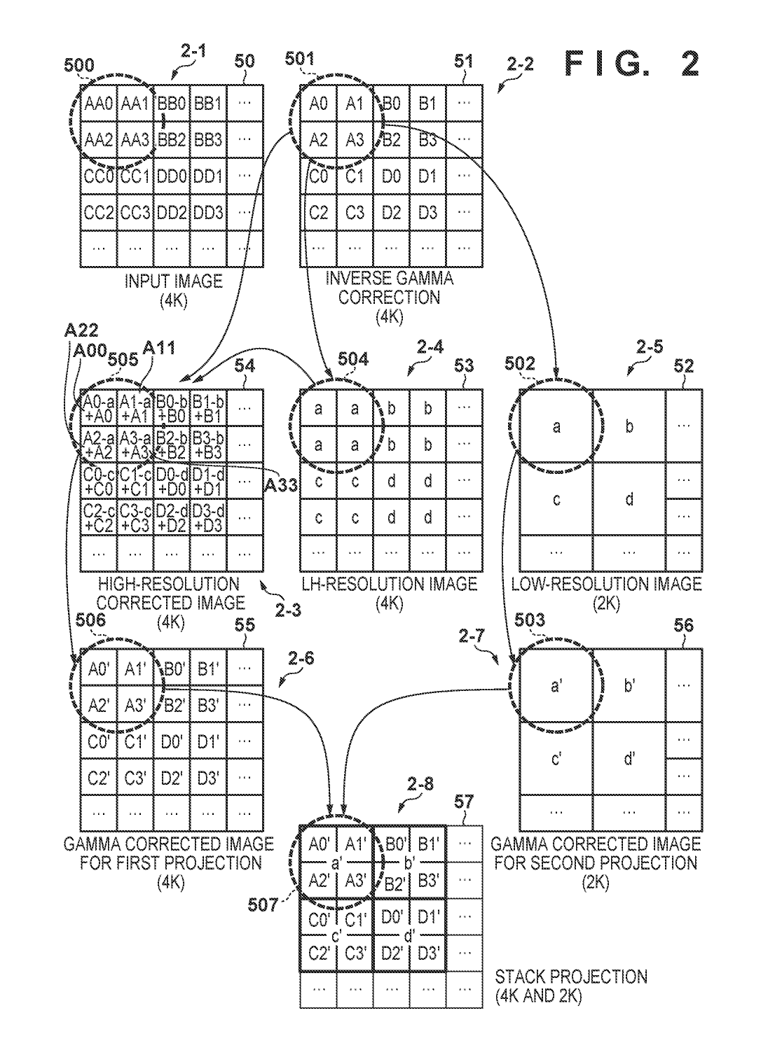

FIG. 2 shows views (FIGS. 2-1 to 2-8) showing processing for stack projection according to the first embodiment.

The processing of the resolution conversion unit 200 will be described first.

FIG. 2-1 shows a 4K input image 50. A pixel set 500 includes four adjacent pixels as corrected pixels of resolution conversion, which have pixel values of (AA0, AA1, AA2, and AA3).

FIG. 2-2 shows an image 51 obtained by performing inverse gamma correction for the input image 50 shown in FIG. 2-1. A pixel set 501 corresponds to the pixel set 500 of the input image corrected by the inverse gamma correction unit 100. The pixel values of the pixel set 501 are (A0, A1, A2, and A3).

The resolution conversion unit 200 performs resolution conversion for the image 51 to generate a 2K low-resolution image 52 shown in FIG. 2-5. A pixel 502 corresponds to the pixel set 501. The pixel value (a) of the pixel 502 is obtained by calculating the average value of the pixel values (A0, A1, A2, and A3) of the pixel set 501, given by:

a=(A0+A1+A2+A3)/4 (1)

Furthermore, the resolution conversion unit 200 generates an LH-resolution image 53 shown in FIG. 2-4. As for the LH-resolution image 53, a resolution is as high as that of the input image but a change in tone of each pixel is the same as in the low-resolution image 52. That is, the pixel values of a pixel set 504 corresponding to the pixel 502 are equal to the pixel value (a) of the pixel 502.

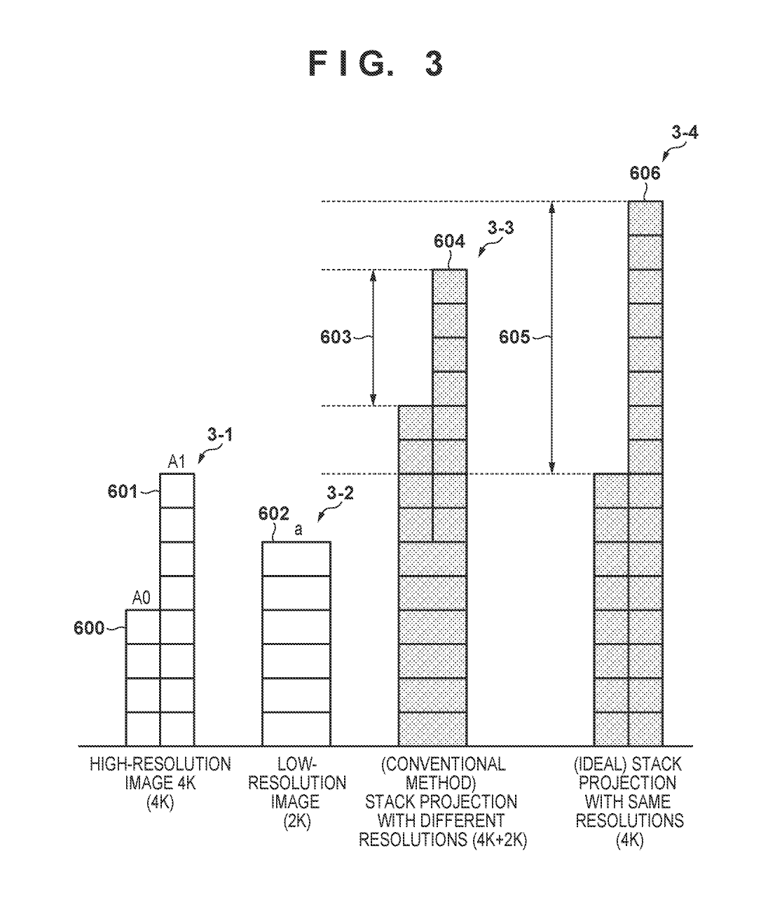

Next, the processing of the image correction unit 300 will be described. The image correction unit 300 corrects the image 51 corrected by the inverse gamma correction unit 100, thereby generating a high-resolution corrected image 54. At this time, the differences between the pixel values of the LH-resolution image 53 generated by the resolution conversion unit 200 and those of the image 51 having undergone inverse gamma correction are used as correction values. FIG. 2-3 shows detailed processing. A pixel set 505 of the image 54 is generated based on the pixel set 501 of the image 51 and the pixel set 504 of the image 53. The pixel values (A00, A11, A22, and A33) of the pixel set 505 are generated from the pixel values (A0, A1, A2, and A3) of the pixel set 501 and the pixel values (a, a, a, and a) of the pixel set 504, given by:

A00=A0−a+A0 (2)

A11=A1−a+A1 (3)

A22=A2−a+A3 (4)

A33=A3−a+A3 (5)

Note that equalities (2) to (5) above may be rewritten into:

A00=2A0−a (6)

A11=2A1−a (7)

A22=2A2−a (8)

A33=2A3−a (9)

Multiplication can be replaced by a bit shift.

As described above, the image correction unit 300 corrects the high-resolution input image. The high-resolution corrected image 54 undergoes gamma correction by the gamma correction unit 101, thereby obtaining an image 55 shown in FIG. 2-6. A pixel set 506 (pixel values (A0′, A1′, A2′, and A3′)) corresponds to the pixel set 505 (pixel values (A00, A11, A22, and A33)).

The low-resolution image 52 undergoes gamma correction by the gamma correction unit 102, thereby obtaining an image 56 shown in FIG. 2-7. A pixel 503 (pixel value (a′)) corresponds to the pixel 502 (pixel value (a)).

The image 55 undergoes stack projection by the 4K projector 40 on the screen 30, and the image 56 undergoes stack projection by the 2K projector 42 on the screen 30. That is, as shown in FIG. 2-8, an image 57 in which the pixel set 506 and the pixel 503 overlap each other in a region 507 is projected.

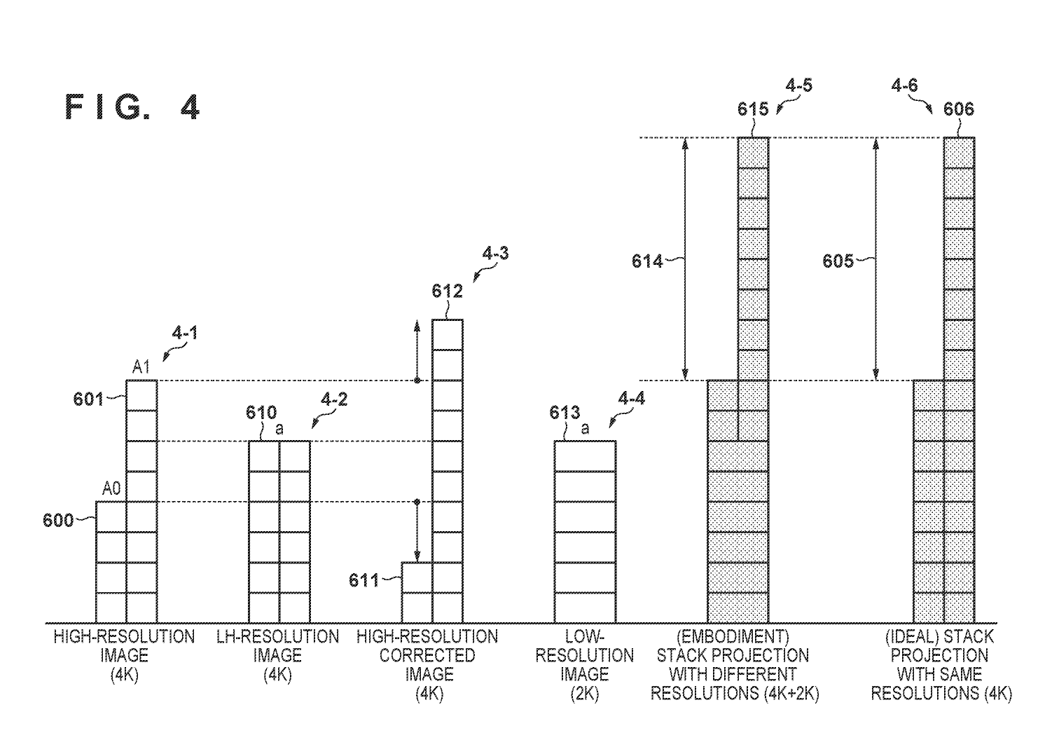

Next, the effect of stack projection according to the first embodiment will be described with reference to FIGS. 3 and 4. FIGS. 3 are views (FIGS. 3-1 to 3-4) schematically, one-dimensionally showing the pixels of a projected image when projectors of different resolutions are used to perform typical stack projection. The abscissa represents a horizontal coordinate position, and the ordinate represents a pixel value. Pixels 600 and 601 shown in FIG. 3-1 correspond to the two pixels of the pixel values (A0 and A1), which are adjacent to each other in the pixel set 501 shown in FIG. 2-2. A pixel 602 shown in FIG. 3-2 corresponds to the pixel 502 of the low-resolution image 52 shown in FIG. 2-5. For the sake of one-dimensional descriptive convenience, the average value of the pixel values of the pixels 600 and 601 is set as the pixel value of the pixel 602. FIG. 3-3 shows a pixel value 604 and contrast 603 obtained when performing stack projection of the pixel 602 of the low-resolution image on the pixels 600 and 601 of the high-resolution image. The contrast indicates the difference between the image signals of adjacent pixels. As the difference is larger, an image with higher sharpness/resolution can be obtained. FIG. 3-4 shows an ideal pixel value 606 and contrast 605 and obtained when two high-resolution projectors are stacked. When comparing the contrast 603 of typical stack projection with the contrast 605 of ideal stack projection, it is apparent that in the general method, the contrast is low and it is impossible to obtain a high resolution.

FIG. 4 are schematic views (FIGS. 4-1 to 4-6) when stack projection is performed according to the first embodiment. A pixel set 610 shown in FIG. 4-2 corresponds to the pixel set 504 (pixel value (a)) of the LH-resolution image 53 shown in FIG. 2-4.

Pixels 611 and 612 shown in FIG. 4-3 correspond to two pixels adjacent to each other in the pixel set 505 of the high-resolution corrected image 54 shown in FIG. 2-3. The pixel value of the pixel 611 is obtained by subtracting, from the pixel value of the pixel 600, a correction value as the difference between the pixel value of the LH-resolution pixel set 610 and that of the high-resolution pixel 600. The pixel value of the pixel 612 is obtained by adding, to the pixel value of the pixel 601, the difference between the pixel value of the pixel 601 and that of the pixel set 610.

A pixel 613 shown in FIG. 4-4 corresponds to the pixel 502 of the low-resolution image 52 shown in FIG. 2-5. For the sake of descriptive convenience of one dimension, the average value of the pixel values of the pixels 600 and 601 is set as the pixel value of the pixel 613.

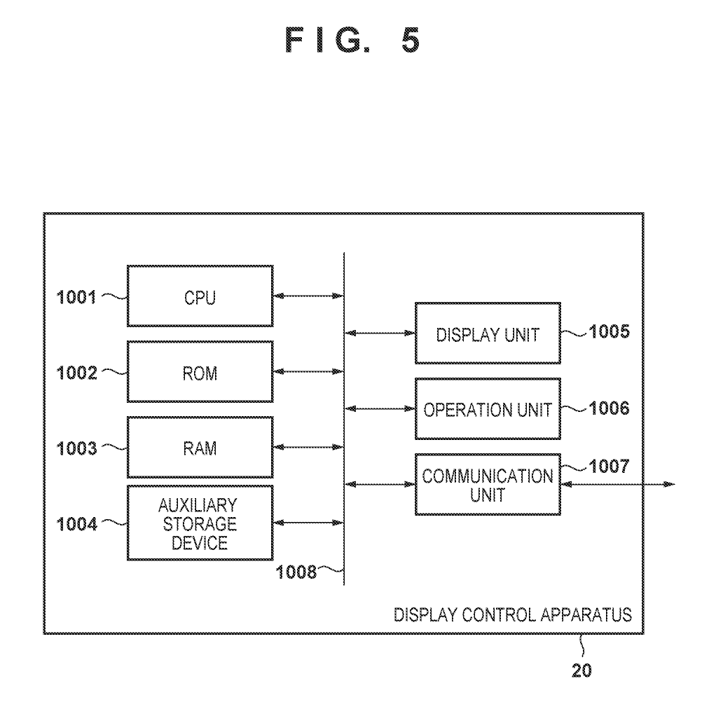

FIG. 4-5 shows a pixel value 615 and contrast 614 obtained when performing stack projection of the high-resolution corrected image (pixels 611 and 612) and the low-resolution image (pixel 613). When comparing the contrast 614 of the first embodiment with the ideal contrast 605 shown in FIG. 4-6 and obtained when the two high-resolution projectors are stacked, it is apparent that the contrasts are equal to each other, and a high resolution can be obtained.

Note that as a method of generating a low-resolution image in the resolution conversion unit 200, a method of calculating the average value of the input image, that is, the high-resolution image is adopted. However, the calculation method is not limited to this. For example, calculation may be performed by setting, as a pixel of a low-resolution image, a pixel having a value ranging from a minimum value (inclusive) to an average value (inclusive) among pixels to be interpolated. This is because, as indicated by equations (2) to (9) of the high-resolution corrected image described above, as the pixel value a of the low-resolution image is smaller, an underflow is more difficult to occur, and the occurrence of black floating caused by an underflow can be suppressed accordingly. For example, an average value (to be described in the second embodiment) calculated in a gamma space, a value obtained by multiplying the average value by a coefficient of 1.0 or less, the median of the pixels to be interpolated, or a value smaller than the median is calculated as a pixel of the low-resolution image. The first embodiment explains the schematic arrangement including the two projection apparatuses. However, even if three or more projection apparatuses are provided, it is possible to correct a high-resolution image with a low-resolution image. Furthermore, the first embodiment describes the schematic arrangement of stack projection for making the entire images overlap each other in an image projection region. Even in tile projection for making images partially overlap each other in the image projection region, it is possible to correct the high-resolution image with the low-resolution image only in the overlapping portion.

FIG. 5 is a block diagram showing an example of the hardware arrangement of the display control apparatus 20. The display control apparatus 20 includes a CPU 1001, a ROM 1002, a RAM 1003, an auxiliary storage device 1004, a display unit 1005, an operation unit 1006, a communication unit 1007, and a bus 1008.

The CPU 1001 controls the overall display control apparatus 20 using computer programs and data stored in the ROM 1002 and the RAM 1003. That is, when the CPU 1001 operates in accordance with programs stored in the ROM 1002 and the like, the function of the display control apparatus 20 described with reference to FIG. 1 is implemented.

The ROM 1002 stores programs and parameters which need not be changed. The RAM 1003 temporarily stores programs and data supplied from the auxiliary storage device 1004, data externally supplied via the communication unit 1007, and the like. The auxiliary storage device 1004 is formed from, for example, a hard disk drive.

The display unit 1005 is formed from, for example, a liquid crystal display and displays, for example, a GUI (Graphical User Interface) for operating the display control apparatus 20. The operation unit 1006 is formed from, for example, a keyboard and a mouse, receives an operation by the user, and inputs various instructions to the CPU 1001. The communication unit 1007 communicates with an external device. The bus 1008 connects the respective components of the display control apparatus 20 and transmits information.

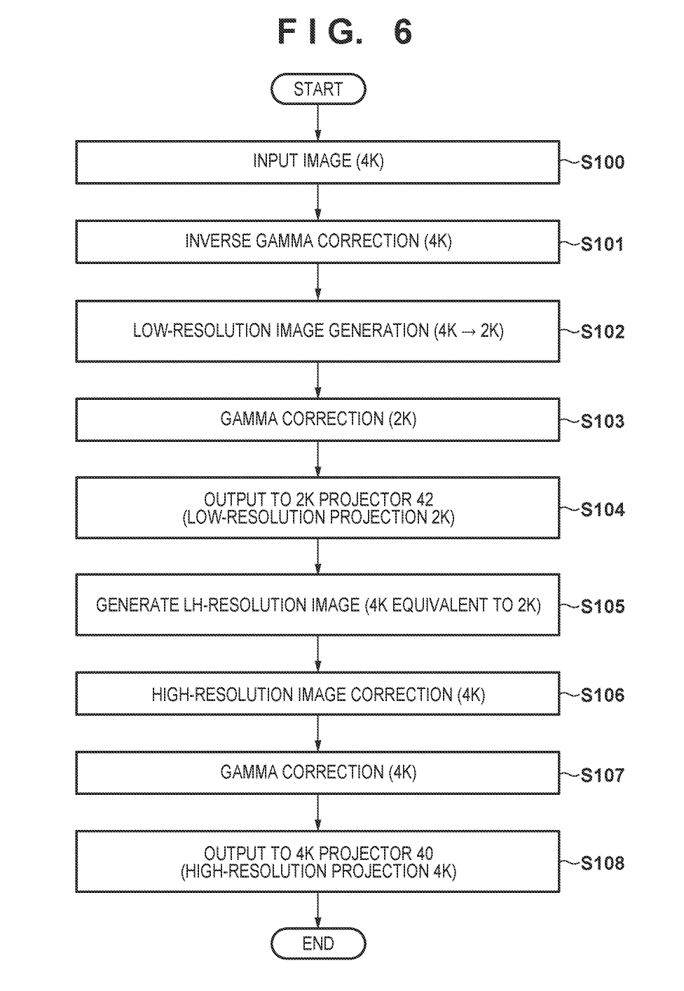

FIG. 6 is a flowchart illustrating the processing of the display control apparatus 20 according to the first embodiment. The processing shown in FIG. 6 is implemented when the CPU 1001 causes each block (see FIG. 1) of the display control apparatus 20 to function by loading a program stored in the ROM 1002 into the RAM 1003 and executing it.

In step S100, a high-resolution (4K) input image is input to the display control apparatus 20 (corresponding to FIG. 2-1). In step S101, the inverse gamma correction unit 100 performs inverse gamma correction for the input image (corresponding to FIG. 2-1→FIG. 2-2).

In step S102, the resolution conversion unit 200 generates a low-resolution image from the luminance linear input image (corresponding to FIG. 2-2→FIG. 2-5). By generating an image in a luminance linear space, it is possible to compute and calculate a physically correct pixel value. General image processing is performed in the luminance linear space.

In step S103, the projector 102 performs gamma correction for the low-resolution image generated in step S102 (corresponding to FIG. 2-5→FIG. 2-7). In step S104, the output unit 400 outputs the low-resolution image having undergone gamma correction to the 2K projector 42 (corresponding to FIG. 2-7→FIG. 2-8).

In step S105, the resolution conversion unit 200 generates an LH-resolution image from the luminance linear input image (corresponding to FIG. 2-2→FIG. 2-4). In step S106, the image correction unit 300 corrects the luminance linear input image using, as correction values, the differences between the pixel values of the luminance linear input image and those of the LH-resolution image, thereby generating a high-resolution corrected image (corresponding to FIGS. 2-2 and 2-4→FIG. 2-3).

In step S107, the gamma correction unit 101 performs gamma correction for the high-resolution corrected image (corresponding to FIG. 2-3→FIG. 2-6). In step S108, the output unit 400 outputs the high-resolution corrected image having undergone gamma correction to the 4K projector 40 (corresponding to FIG. 2-6→FIG. 2-8). Then, the processing terminates.

In accordance with the processes in steps S104 and S108, the projectors 40 and 42 project the images on the screen 30, thereby implementing high-resolution stack projection.

For the sake of descriptive convenience, the above embodiment has explained an example in which the ratio between the resolution (pixel count) of the high-resolution projection apparatus and that of the low-resolution projection apparatus is 2:1 in the vertical and horizontal directions.

However, even if the ratio between the resolutions is 3:1, after creating a low-resolution image, a high-resolution image can be created using the difference between the input image and the low-resolution image, as in the case in which the ratio between the resolutions is 2:1. Instead of creating a low-resolution image from four pixels in total in the vertical and horizontal directions of the input image, if the ratio between the resolutions is 3:1, a low-resolution image is created from nine pixels in total in the vertical and horizontal directions of the input image.

If the resolution (pixel count) of the high-resolution projection apparatus is not an integer multiple of the resolution (pixel count) of the low-resolution projection apparatus, it is necessary to use pixel interpolation to create a low-resolution image. If a given pixel of the low-resolution image corresponds to a plurality of pixels of the input image, it is necessary to perform interpolation by changing weighting in accordance with the distance to each of the plurality of pixels. By using the linear interpolation method which is commonly used, calculation can be performed by:

a=A0*(1−α)*(1−β)+A1*α*(1−β)+A2*(1−α)*β+A3*α*β (10)

If keystone deformation is used to stack the projectors, the same interpolation calculation as that described above is performed to create a geometrically deformed low-resolution image even in the case of a combination of resolutions one of which is an integer multiple of the other. Note that keystone deformation is desirably performed on the low-resolution projector side, and deformation calculation may be performed by a deformation function in the projector. As for the high-resolution projector, it is desirable not to perform keystone deformation since the resolution is reduced but keystone deformation may be performed for the sake of installation convenience.

As described above, according to the first embodiment, a low-resolution image is generated from a high-resolution input image, and the input image is corrected based on the differences between the pixel values of the input image and those of the low-resolution image, thereby generating a high-resolution corrected image. This can obtain a high resolution at the time of stack projection by projectors of different resolutions.

### Second Embodiment

In the first embodiment, a low-resolution image is generated from a high-resolution image after inverse gamma correction. In the second embodiment, a low-resolution image is generated from a high-resolution image before inverse gamma correction. This can suppress an underflow occurring when correcting a high-resolution image.

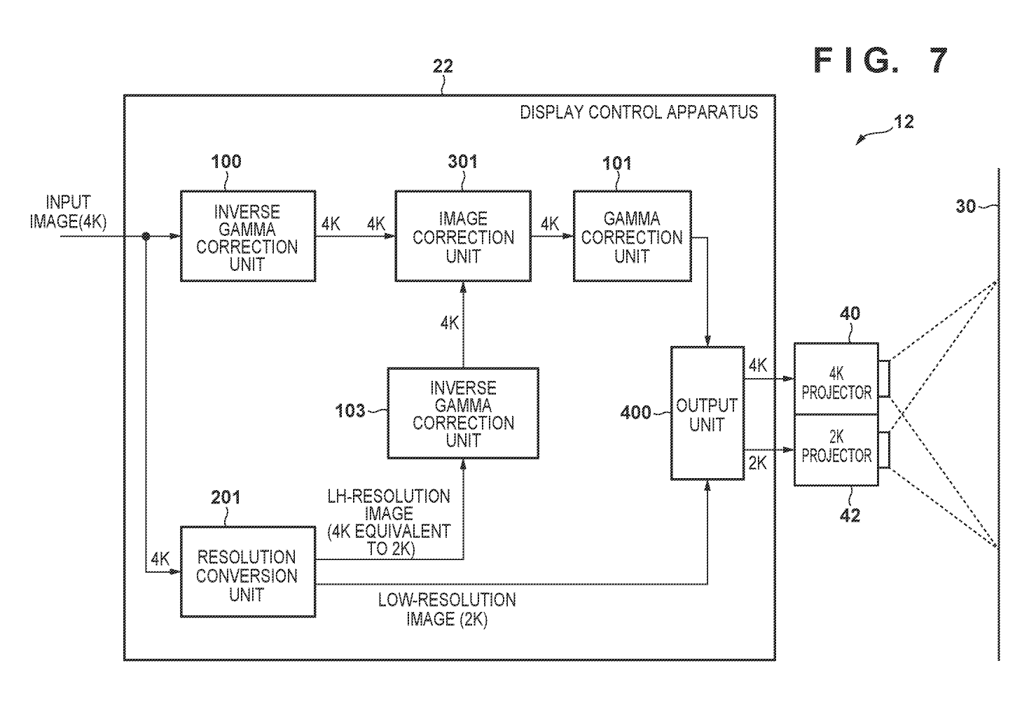

FIG. 7 is a view showing an example of the schematic arrangement of an image projection system 12 according to the second embodiment. Blocks denoted by the same reference numerals as in the image projection system 11 according to the first embodiment represent the same functional components and a description thereof will be omitted.

The image projection system 12 is formed from a display control apparatus 22, projectors 40 and 42, and a screen 30. A high-resolution (4K) image is input to the display control apparatus 22, and output to the 4K projector 40 and the 2K projector 42.

The display control apparatus 22 includes inverse gamma correction units 100 and 103, a gamma correction unit 101, a resolution conversion unit 201, an image correction unit 301, and an output unit 400.

The resolution conversion unit 201 generates, from the 4K input image before inverse gamma correction, a 2K low-resolution image and an LH-resolution image whose change in tone of each pixel is 2K and whose resolution is 4K. The 2K projector 42 projects the generated low-resolution image via the output unit 400.

The image correction unit 301 generates a high-resolution corrected image based on the 4K input image having undergone inverse gamma correction by the inverse gamma correction unit 100 and the LH-resolution image having undergone inverse gamma correction by the inverse gamma correction unit 103.

The gamma correction unit 101 performs gamma correction for the high-resolution corrected image generated by the image correction unit 301. The 4K projector 40 projects this image via the output unit 400.

The difference from the display control apparatus 20 according to the first embodiment is that an LH-resolution image is generated by the resolution conversion unit 201 before inverse gamma correction. This can set relatively small pixel values of the LH-resolution image, as compared to a case in which an LH-resolution image is generated after inverse gamma correction, thereby performing stack projection while suppressing black floating of a high-resolution corrected image. This will be described in detail with reference to FIGS. 8-1 to 8-14 and 9.

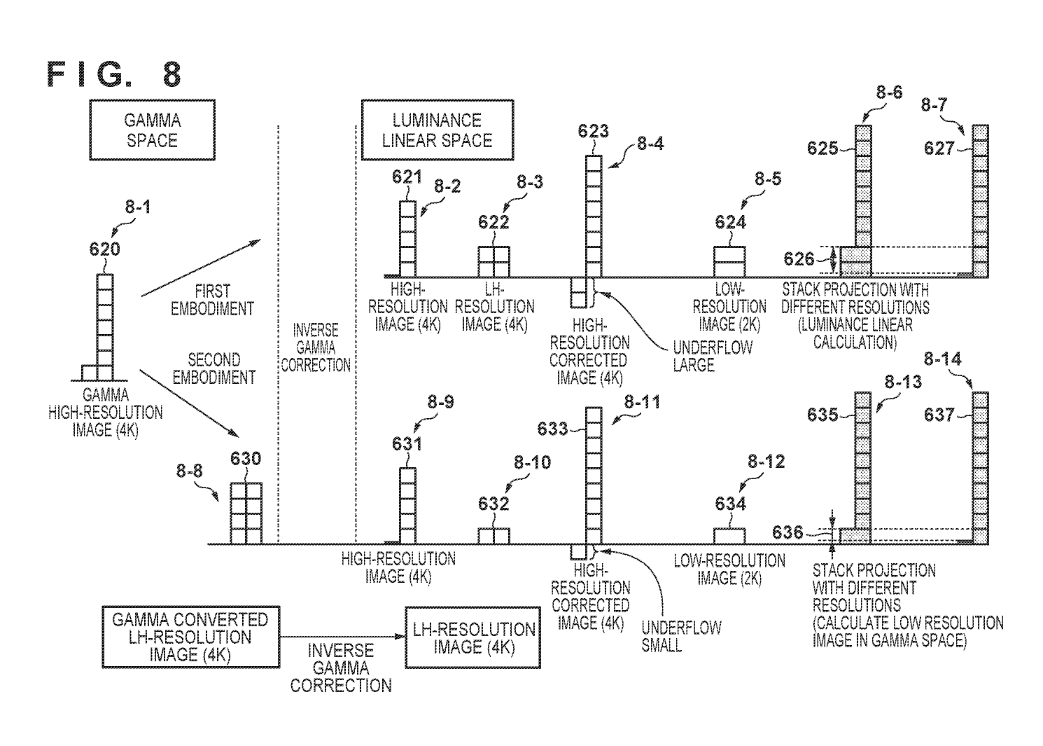

FIG. 8 shows views (FIGS. 8-1 to 8-14) for explaining comparison between stack projection performed in the first embodiment and that performed in the second embodiment. As in the case explained with reference to FIG. 3, FIGS. 8-1 to 8-14 schematically, one-dimensionally show the pixels of the projected image, in which the abscissa represents a horizontal coordinate position, and the ordinate represents a pixel value.

FIG. 8-1 shows some adjacent pixels (pixel value 620) of a high-resolution image as the 4K input image before the inverse gamma correction. A series of processes shown in FIGS. 8-2 to 8-6 indicates the processing in the first embodiment for generating a high-resolution corrected image by generating an LH-resolution image after performing inverse gamma correction for that image, and pixels shown in FIGS. 8-2 to 8-7 correspond to the pixels shown in FIG. 8-1. FIG. 8-2 shows pixels (pixel value 621) of an image obtained by performing inverse gamma correction for the 4K input image. A pixel value 622 in the LH-resolution image shown in FIG. 8-3 is obtained by averaging the pixels shown in FIG. 8-2. The same applies to a pixel value 624 of the low-resolution image shown in FIG. 8-5. That is, the pixel values 622 and 624 are equal to each other. FIG. 8-4 shows a pixel value 623 of a corrected pixel of the high-resolution image obtained, as described in the first embodiment, by:

pixel value 623 of corrected image=pixel value 621 of high-resolution image+(pixel value 621 of high-resolution image−pixel value 622 of LH-resolution image) (11)

That is, the differences between the pixel values of the high-resolution image and those of the low-resolution image generated by resolution conversion are set as correction values of the high-resolution image.

However, as shown in FIG. 8-4, if the pixel value of the LH-resolution image is larger than the pixel value of the high-resolution image by a predetermined value or more, particularly when an underflow occurs in equation (11), the correction value of the high-resolution corrected image is unwantedly clipped. In this state, if the image is stacked with the low-resolution image (pixel value 624) shown in FIG. 8-5, an image (pixel value 625) shown in FIG. 8-6 is projected.

FIG. 8-7 shows pixels (pixel value 627) of an image obtained by stacking two high-resolution images shown in FIG. 8-2. When the pixel values 625 and 627 are compared with each other, a difference 626 is obtained to cause black floating, which is visually perceived as blurring.

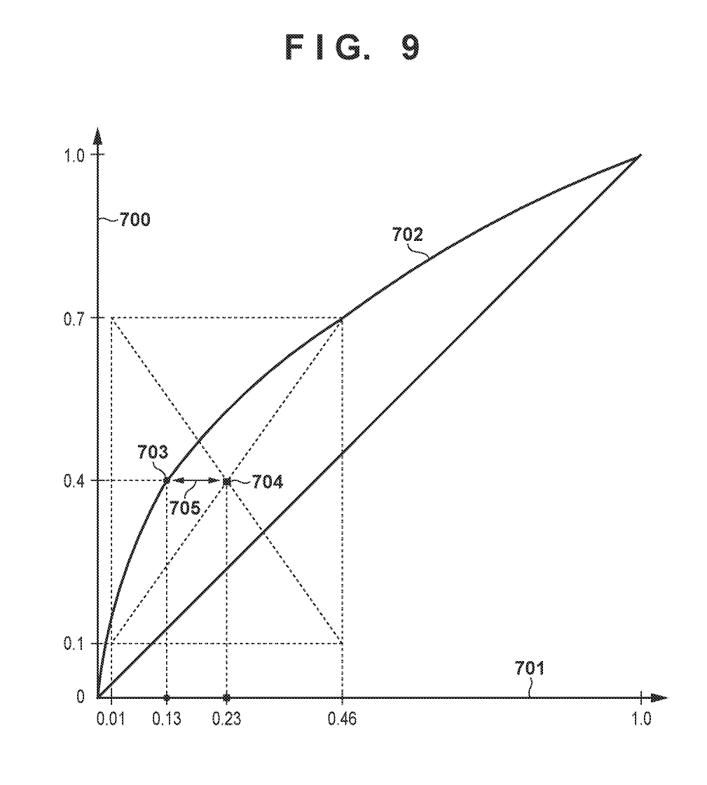

On the other hand, in a series of processes shown in FIGS. 8-8 to 8-13 according to the second embodiment, pixel values of the LH-resolution image (pixel value 630) are generated from the average value of the pixel values of the high-resolution image (pixel value 620) as the 4K input image before inverse gamma correction. Then, the generated image undergoes inverse gamma correction, thereby generating an LH-resolution image (pixel value 632). When comparing the pixel value 622 shown in FIG. 8-3 with the pixel value 632 shown in FIG. 8-10, the pixel value 632 as the average value calculated before inverse gamma correction is smaller. This will be described with reference to FIG. 9.

FIG. 9 is a graph showing gamma characteristics. Referring to FIG. 9, an ordinate 700 represents a pixel value corresponding to a gamma space ((1/2.2)th power), and an abscissa 701 represents a luminance linear pixel value. A curve 702 is a gamma ((1/2.2)th power) curve. A point 703 indicates the average value of 0.7 and 0.1 in the gamma space, and a point 704 indicates an average value in the luminance linear space obtained by performing inverse gamma correction for 0.7 and 0.1 in the gamma space. As represented by the curve 702, the curve rises upward, and thus the luminance linear average value decreases by an amount corresponding to an arrow 705.

As described above, by generating the small pixel value 632 of the LH-resolution image shown in FIG. 8-10, an underflow of a pixel value 633 of the high-resolution corrected image is suppressed. When the thus corrected high-resolution image and the low-resolution image undergo stack projection, it is possible to obtain a high resolution while suppressing black floating caused by an underflow.

Note that in the second embodiment, a low-resolution image is created using gamma tone value before inverse gamma correction. However, a method of calculating a low-resolution image is not limited to this. As for a target pixel value of the input image, the average value of linear tone values is set as an upper limit, the tone value of the lowest tone pixel is set as a lower limit, and a value between the upper limit and the lower limit is set in a low-resolution image. The reason why the gamma system is used is that the input image often has gamma tone values.

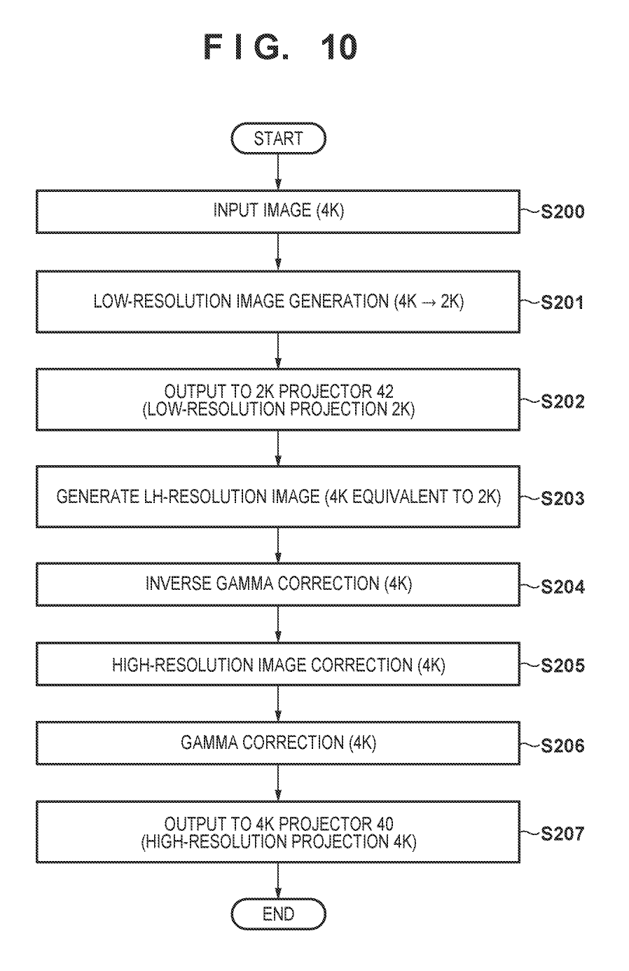

FIG. 10 is a flowchart illustrating the processing of the display control apparatus 22 according to the second embodiment.

In step S200, a high-resolution (4K) input image is input to the display control apparatus 22. In step S201, the resolution conversion unit 201 generates a low-resolution image from the input image before inverse gamma correction. In step S202, the output unit 400 outputs the low-resolution image generated by the resolution conversion unit 201 to the 2K projector 42.

In step S203, the resolution conversion unit 201 generates an LH-resolution image from the input image before inverse gamma correction. In step S204, the inverse gamma correction unit 103 performs inverse gamma correction for the generated LH-resolution image.

In step S205, the image correction unit 301 corrects, using, as correction values, the differences between the pixel values of the LH-resolution image and those of the input image having undergone inverse gamma correction, the input image having undergone inverse gamma correction, thereby generating a high-resolution corrected image.

In step S206, the gamma correction unit 101 performs gamma correction for the high-resolution corrected image. In step S207, the output unit 400 outputs the high-resolution corrected image having undergone gamma correction to the 4K projector 40.

In accordance with the processes in steps S202 and S207, the projectors 40 and 42 project the images on the screen 30, thereby implementing high-resolution stack projection.

As described above, according to the second embodiment, an underflow occurring when correcting a high-resolution image is suppressed by generating a low-resolution image before inverse gamma correction, thereby suppressing black floating. This can obtain a high resolution at the time of stack projection by projectors of different resolutions.

### Third Embodiment

According to the third embodiment, a high-resolution (4K) image and a low-resolution (2K) image are input. The third embodiment is different from the first and second embodiments in that the high-resolution image is corrected based on an LH-resolution image generated from the low-resolution image before inverse gamma correction.

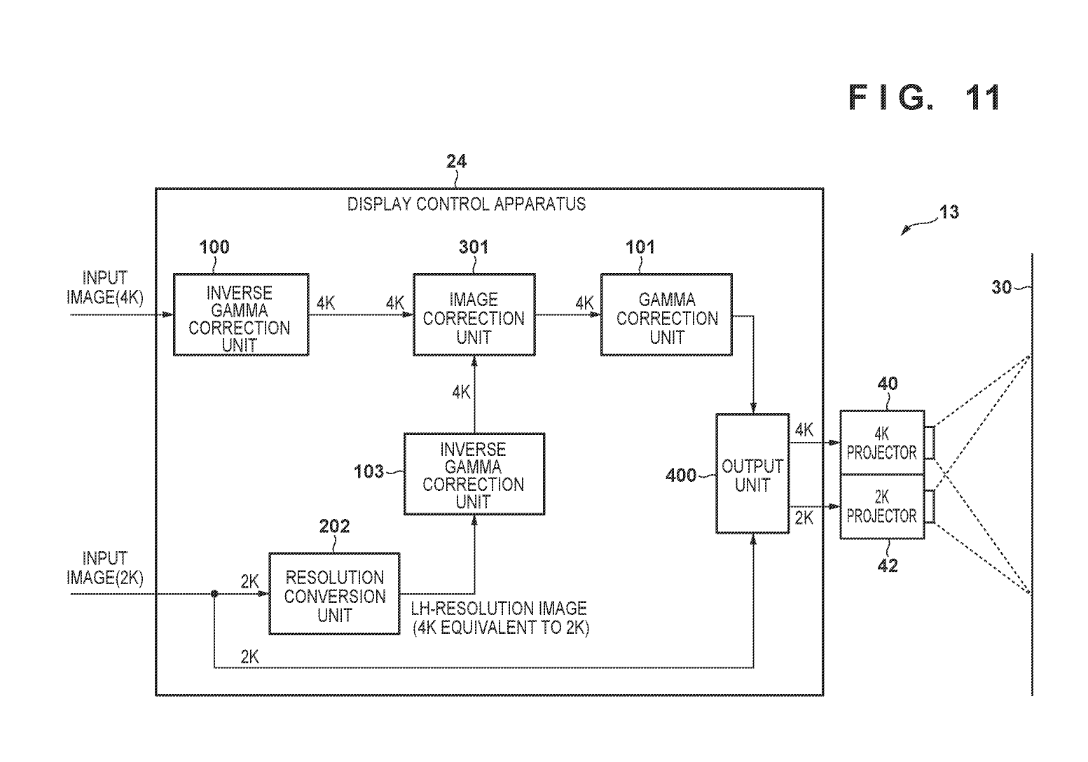

FIG. 11 is a view showing an example of the schematic arrangement of an image projection system 13 according to the third embodiment. Blocks denoted by the same reference numerals as in the first and second embodiments represent the same functional components and a description thereof will be omitted.

An image projection system 13 is formed from a display control apparatus 24, projectors 40 and 42, and a screen 30. A high-resolution (4K) image and a low-resolution (2K) image are input to the display control apparatus 24, undergo resolution conversion, image correction, and the like, and are then output to the 4K projector 40 and the 2K projector 42.

The display control apparatus 24 includes inverse gamma correction units 100 and 103, a gamma correction unit 101, a resolution conversion unit 202, an image correction unit 301, and an output unit 400. The resolution conversion unit 202 generates an LH-resolution image from the 2K input image.

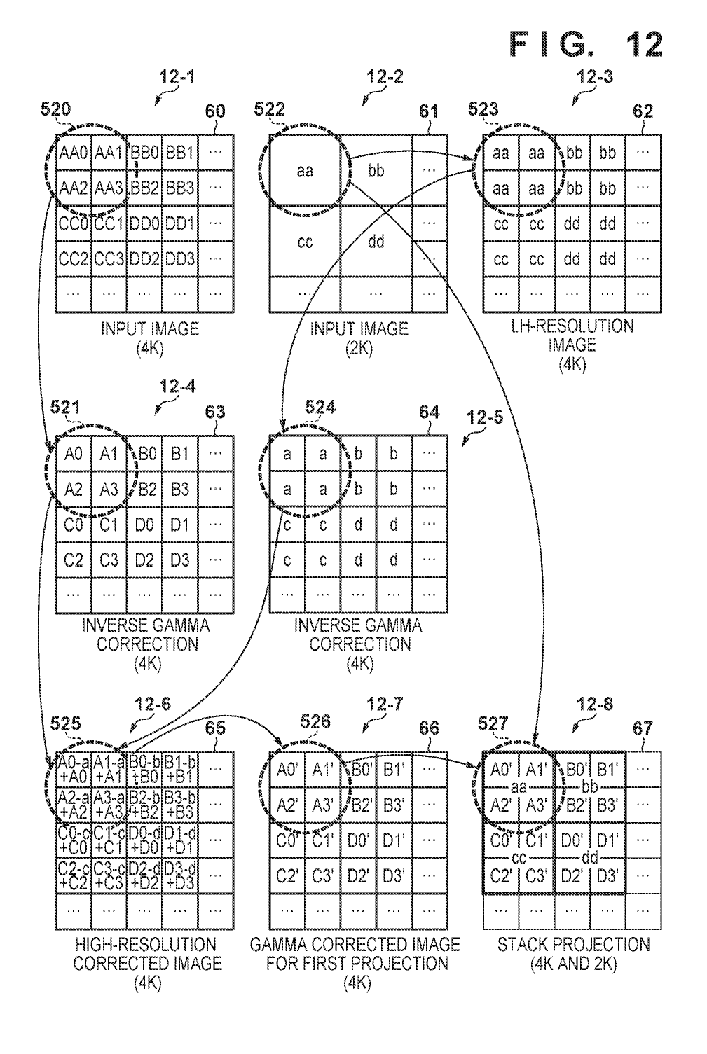

FIG. 12 shows views (FIGS. 12-1 to 12-8) showing processing for stack projection according to the third embodiment. A pixel 522 of a 2K input image 61 shown in FIG. 12-2 is output to the 2K projector 42 as a pixel corresponding to a region 527 of a stack projection image 67 shown in FIG. 12-8. The resolution conversion unit 202 converts the pixel 522 of the 2K input image 61 into a pixel set 523 of an LH-resolution image 62 shown in FIG. 12-3.

Next, the inverse gamma correction unit 103 performs inverse gamma correction for the LH-resolution image 62 to generate an image 64 shown in FIG. 12-5. A pixel set 524 of the image 64 is obtained as a result of performing inverse gamma correction for the pixel set 523 of the LH-resolution image 62. At the same time, the inverse gamma correction unit 100 performs inverse gamma correction for a 4K input image 60 shown in FIG. 12-1 to generate an image 63 shown in FIG. 12-4. A pixel set 521 of the image 63 is obtained as a result of performing inverse gamma correction for a pixel set 520 of the 4K input image 60.

The image correction unit 301 generates a high-resolution corrected image 65 shown in FIG. 12-6 based on the images 63 and 64 having undergone inverse gamma correction. As described in the first embodiment, pixel values of a pixel set 525 are generated using, as correction values, the differences between the pixel values of the pixel set 521 and those of the pixel set 524.

The gamma correction unit 101 performs gamma correction for the high-resolution corrected image 65 to generate an image 66 shown in FIG. 12-7. The image 66 is output to the 4K projector 40 via the output unit 400. A pixel set 526 is obtained as a result of performing gamma correction for the pixel set 525.

As a result, as shown in FIG. 12-8, the region 527 where the pixel 522 and the pixel set 526 overlap each other undergoes stack projection on the screen 30.

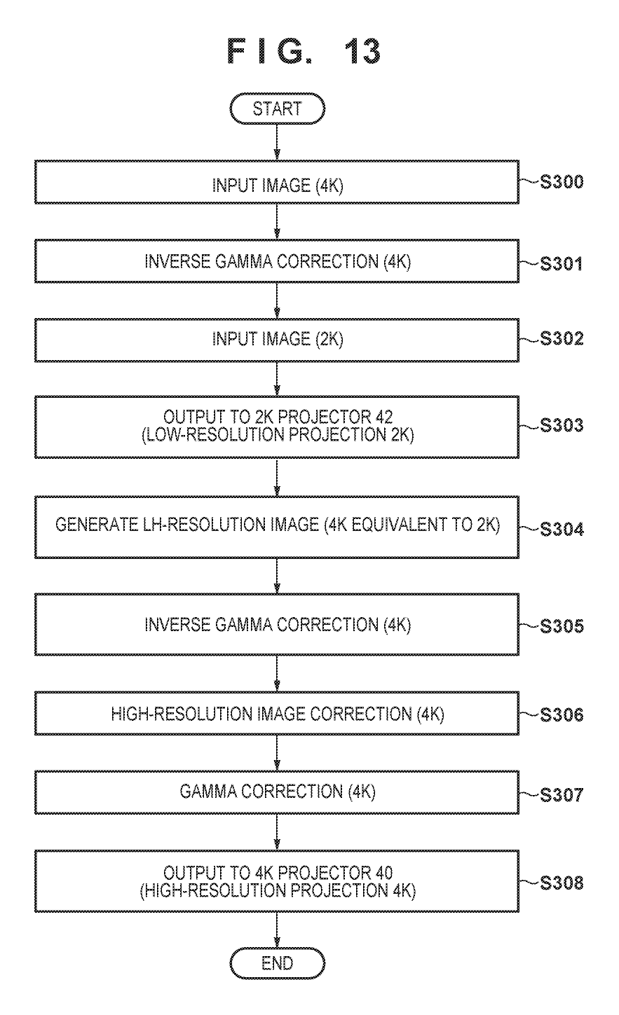

FIG. 13 is a flowchart illustrating the processing of the display control apparatus 24 according to the third embodiment.

In step S300, a high-resolution (4K) input image is input to the inverse gamma correction unit 100 (corresponding to FIG. 12-1). In step S301, the inverse gamma correction unit 100 performs inverse gamma correction for the input image (corresponding to FIG. 12-1→FIG. 12-4).

A low-resolution (2K) input image is input in step S302 (corresponding to FIG. 12-2), and output to the 2K projector 42 via the output unit 400 in step S303 (corresponding to FIG. 12-2→FIG. 12-8).

In step S304, the resolution conversion unit 202 generates an LH-resolution image from the 2K input image (corresponding to FIG. 12-2→FIG. 12-3). In step S305, the inverse gamma correction unit 103 performs inverse gamma correction for the generated LH-resolution image (corresponding to FIG. 12-3→FIG. 12-5).

In step S306, the image correction unit 301 generates a high-resolution corrected image based on the 4K input image and LH-resolution image, both of which have undergone inverse gamma correction (corresponding to FIGS. 12-4 and 12-5→FIG. 12-6). In step S307, the gamma correction unit 101 performs gamma correction for the high-resolution corrected image (corresponding to FIG. 12-6→FIG. 12-7). In step S308, the thus obtained image is output to the 4K projector 40 via the output unit 400 (corresponding to FIG. 12-7→FIG. 12-8).

In accordance with the processes in steps S303 and S308, the projectors 40 and 42 project the images on the screen 30, thereby implementing high-resolution stack projection.

As described above, according to the third embodiment, a high-resolution input image is corrected using the differences between the pixel values of the high-resolution input image and those of a low-resolution input image. This can obtain a high resolution at the time of stack projection by projectors of different resolutions.

### Fourth Embodiment

According to the fourth embodiment, stack projection by projectors of different resolutions is performed for a low-resolution input image.

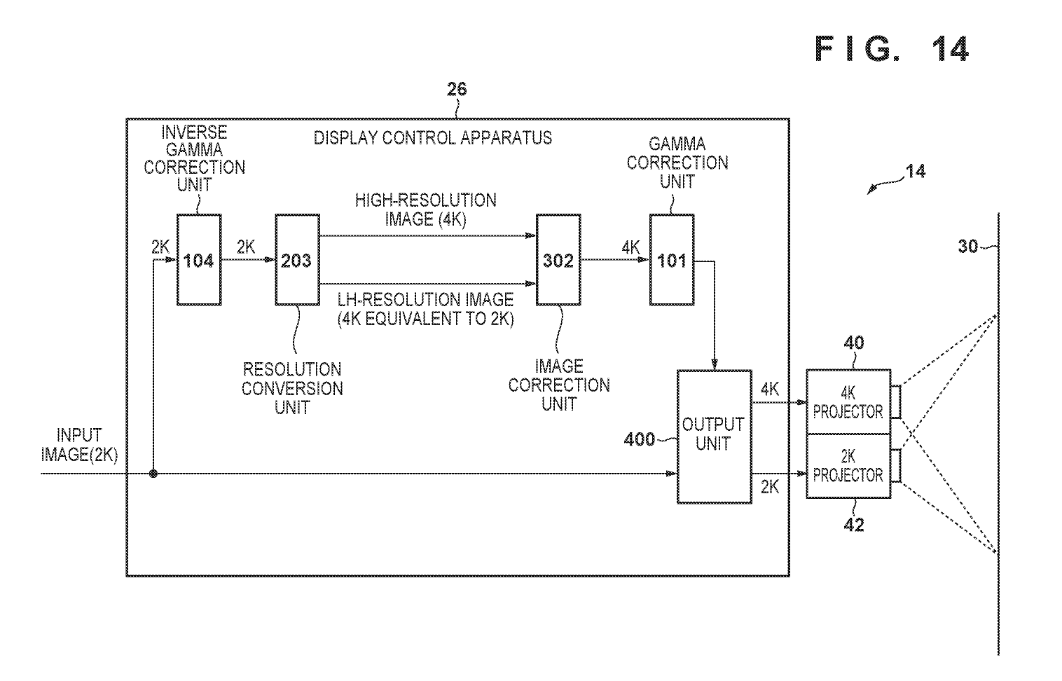

FIG. 14 is a view showing an example of the schematic arrangement of an image projection system 14 according to the fourth embodiment. Blocks denoted by the same reference numerals as in the first to third embodiments represent the same functional components and a description thereof will be omitted.

The image projection system 14 is formed from a display control apparatus 26, projectors 40 and 42, and a screen 30. A low-resolution (2K) image is input to the display control apparatus 26, undergoes resolution conversion, image correction, and the like, and is then output to the 4K projector 40 and the 2K projector 42.

The display control apparatus 26 includes an inverse gamma correction unit 104, a resolution conversion unit 203, an image correction unit 302, a gamma correction unit 101, and an output unit 400.

The inverse gamma correction unit 104 performs gamma correction for the 2K input image. The resolution conversion unit 203 generates a high-resolution image by increasing the resolution of the low-resolution image. For example, the resolution is interpolated by super-resolution technology. In addition, an LH-resolution image is generated from the low-resolution image. The image correction unit 302 corrects the high-resolution image. At this time, the differences between the pixel values of the LH-resolution image and those of the high-resolution image generated by the resolution conversion unit 203 are used as correction values.

The high-resolution corrected image undergoes gamma correction by the gamma correction unit 101, and is output to the 4K projector 40 via the output unit 400. Furthermore, the 2K input image is output to the 2K projector 42 via the output unit 400. The projectors 40 and 42 perform stack projection of the images on the screen 30.

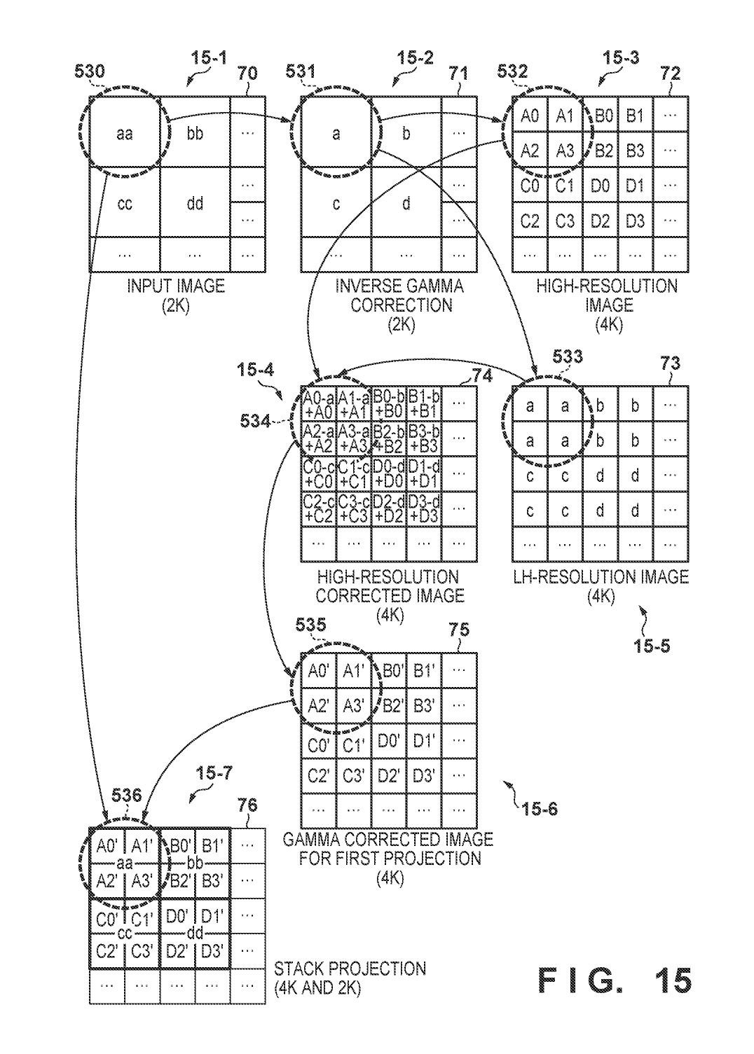

FIG. 15 shows views (FIGS. 15-1 to 15-7) showing processing for stack projection according to the fourth embodiment.

A pixel 530 of a 2K input image 70 shown in FIG. 15-1 is output to the 2K projector 42 as a pixel overlapping a region 536 of a projected image 76 shown in FIG. 15-8. At the same time, the inverse gamma correction unit 104 performs inverse gamma correction for the input image 70 to obtain an image 71 shown in FIG. 15-2. A pixel 531 of the image 71 is obtained as a result of performing inverse gamma conversion for the pixel 530 of the image 70.

Next, the resolution conversion unit 203 converts the image 71 into a high-resolution image 72 shown in FIG. 15-3 and an LH-resolution image 73 shown in FIG. 15-5. Pixel sets 532 and 533 correspond to the pixel 531 of the image 71. Note that super-resolution technology is used as an example of a method of generating a high-resolution image from a low-resolution image.

Both the images 72 and 73 are input to the image correction unit 302 to generate a high-resolution corrected image 74 shown in FIG. 15-4. As described in the first embodiment, pixel values of a pixel set 534 of the high-resolution corrected image 74 are generated based on the differences between the pixel values of the pixel set 532 of the high-resolution image 72 and those of the pixel set 533 of the LH-resolution image 73.

The gamma correction unit 101 performs gamma correction for the high-resolution corrected image 74 into an image 75 shown in FIG. 15-6, and the image 75 is output to the 4K projector 40. As a result, as shown in FIG. 15-7, the image 76 in which the pixel 530 and a pixel set 535 overlap each other in the region 536 undergoes stack projection on the screen 30.

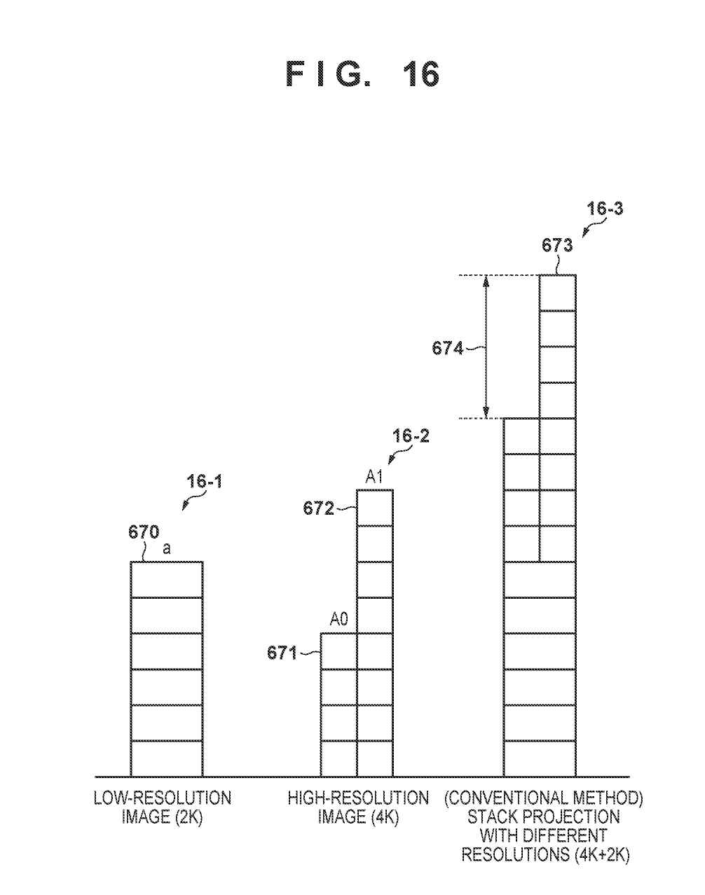

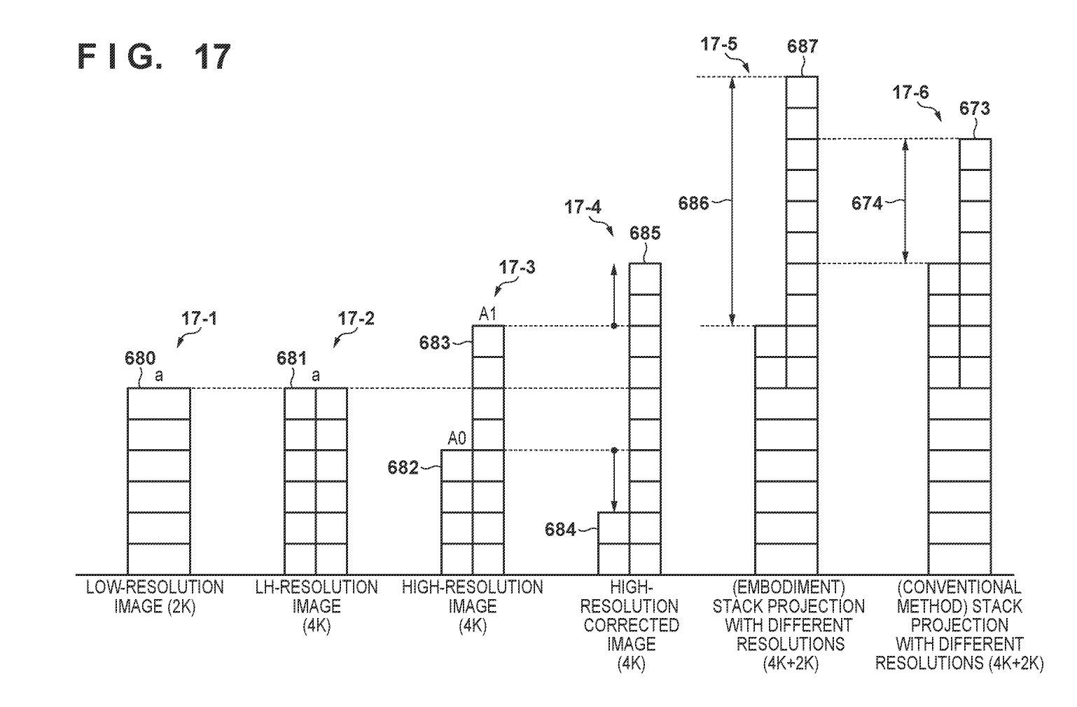

The effect of stack projection according to the fourth embodiment will be described with reference to FIGS. 16 and 17. FIG. 16 shows views (FIGS. 16-1 to 16-3) schematically, one-dimensionally showing the pixels of a projected image when stack projection is performed by a conventional method using projectors of different resolutions. FIG. 16-1 shows a pixel 670 (pixel value a) of an input low-resolution image. FIG. 16-2 shows pixels 671 and 672 (pixel values (A0 and A1)) generated by performing enlargement processing for the low-resolution image shown in FIG. 16-1. FIG. 16-3 shows a pixel value 673 and contrast 674 obtained when stack projection of a high-resolution image shown in FIG. 16-2 is performed on the low-resolution image shown in FIG. 16-1.

FIG. 17 shows schematic views (FIGS. 17-1 to 17-6) when stack projection is performed according to the fourth embodiment. FIG. 17-1 shows a pixel 680 (pixel value a) of an input low-resolution image. FIG. 17-2 shows a pixel set 681 (pixel value a) of an LH-resolution image. FIG. 17-3 shows pixels 682 and 683 (pixel values (A0 and A1) obtained by performing enlargement processing for the low-resolution image shown in FIG. 17-1. FIG. 17-4 shows pixels 684 and 685 of a high-resolution corrected image. FIG. 17-5 shows a pixel 687 and contrast 686 obtained when stack projection is performed for the high-resolution corrected image shown in FIG. 17-4 on the low-resolution image shown in FIG. 17-1. When comparing the contrast 686 of the fourth embodiment with the contrast 674 (FIG. 17-6) obtained by the conventional method, it is apparent that the contrast of the fourth embodiment is higher. Note that although super-resolution technology is used as a method of generating a high-resolution image in the resolution conversion unit 203, the calculation method is not limited to this. The fourth embodiment can also be implemented using an interpolation method such as bilinear or bicubic interpolation.

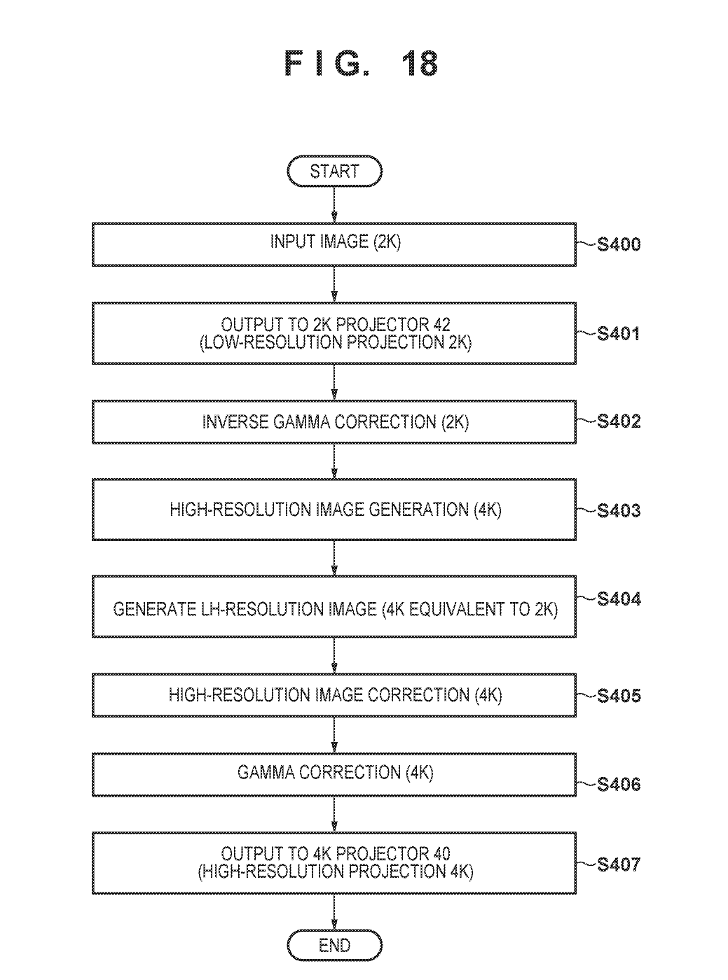

FIG. 18 is a flowchart illustrating the processing of the display control apparatus 26 according to the fourth embodiment.

A low-resolution (2K) input image (corresponding to FIG. 15-1) is input in step S400, and output to the 2K projector 42 in step S401 (corresponding to FIG. 15-8).

In step S402, the inverse gamma correction unit 104 performs inverse gamma correction for the 2K input image (corresponding to FIG. 15-1→FIG. 15-2). In step S403, the resolution conversion unit 203 generates a high-resolution image by super-resolution technology (corresponding to FIG. 15-2→FIG. 15-3). In step S404, the resolution conversion unit 203 generates an LH-resolution image (corresponding to FIG. 15-2→FIG. 15-5).

In step S405, the image correction unit 302 corrects the high-resolution image using the differences between the pixel values of the high-resolution image and those of the LH-resolution image as correction values, thereby generating a high-resolution corrected image (corresponding to FIGS. 15-3 and 15-5→FIG. 15-4). In step S406, the gamma correction unit 101 performs gamma correction for the high-resolution corrected image (corresponding to FIG. 15-4→FIG. 15-6). In step S407, the high-resolution corrected image having undergone gamma correction is output to the 4K projector 40 via the output unit 400. In accordance with steps S401 and S407, the projectors 40 and 42 project the images on the screen 30, thereby implementing high-resolution stack projection (FIG. 15-7).

As described above, according to the fourth embodiment, a high-resolution image is generated for a low-resolution input image, and corrected using the differences between the pixel values of the low-resolution image and those of the high-resolution image, thereby making it possible to obtain a high resolution at the time of stack projection by projectors of different resolutions.

In the fourth embodiment as well, the ratio between the resolutions of the low-resolution projector and high-resolution projector is not limited to a ratio of 2:1. Even if the ratio is 3:1 or 1.75:1, or a keystone is included, high-resolution stack projection can be implemented in the same manner as in the first embodiment.

As described above, according to each embodiment, even if projectors of different resolutions display a plurality of images to overlap each other on a projection surface, it is possible to obtain a high resolution.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-254398, filed Dec. 28, 2017, which is hereby incorporated by reference herein in its entirety.

What is claimed is:

1. A display control apparatus for controlling stack projection by a plurality of projection apparatuses including a first projection apparatus configured to project an image at a first resolution and a second projection apparatus configured to project an image at a second resolution lower than the first resolution, comprising:
an obtaining unit configured to obtain a first image obtained by representing a projection target input image at the first resolution and performing inverse gamma conversion and a second image obtained by representing the input image at the second resolution;
a converting unit configured to convert the second image represented at the second resolution into a third image for which inverse gamma conversion has been performed, for which change in tone of each pixel is the same as in the second image, and for which resolution is represented by the first resolution;
an image correction unit configured to correct a pixel value of each pixel of the first image based on a difference between the pixel value of each pixel of the first image and a pixel value of each pixel of the third image;
a first gamma correction unit configured to perform gamma correction for a corrected image output from the image correction unit; and
an output unit configured to output the corrected image corrected by the first gamma correction unit and the second image to the first projection apparatus and the second projection apparatus, respectively.

2. The apparatus according to claim 1, wherein
the input image is an image of the first resolution, and
the obtaining unit obtains the input image as the first image, and obtains the second image by reducing the resolution of the input image.

3. The apparatus according to claim 2, further comprising an inverse gamma correction unit configured to perform inverse gamma correction for the input image,
wherein the obtaining unit obtains, as the first image, the input image after the inverse gamma correction, and obtains the second image by reducing the resolution of the input image after the inverse gamma correction.

4. The apparatus according to claim 3, further comprising a second gamma correction unit configured to perform gamma correction for the second image obtained by reducing the resolution of the input image after the inverse gamma correction,
wherein the output unit outputs, as the second image, to the second projection apparatus, the image output from the second gamma correction unit.

5. The apparatus according to claim 2, further comprising an inverse gamma correction unit configured to perform inverse gamma correction for the input image,
wherein the obtaining unit obtains the first image by performing inverse gamma correction for the input image, and obtains the second image by reducing the resolution of the input image before the inverse gamma correction, and
the converting unit generates the third image by performing inverse gamma correction for an image obtained by converting the second image into the first resolution.

6. The apparatus according to claim 5, wherein the output unit outputs the corrected first image to the first projection apparatus after performing gamma correction, and outputs the second image to the second projection apparatus.

7. The apparatus according to claim 1, further comprising an inverse gamma correction unit configured to perform inverse gamma correction for the input image,
wherein the obtaining unit obtains the first image by performing inverse gamma correction for the input image represented at the first resolution, and obtains, as the second image, the input image represented at the second resolution, and
the converting unit generates the third image by performing inverse gamma correction for an image obtained by converting the second image into the first resolution.

8. The apparatus according to claim 1, wherein
the input image is an image of the second resolution, and
the obtaining unit obtains the input image as the second image, and obtains the first image by increasing the resolution of the input image.

9. The apparatus according to claim 8, further comprising an inverse gamma correction unit configured to perform inverse gamma correction for the input image,
wherein the obtaining unit obtains the first image by increasing the resolution of the input image having undergone the inverse gamma correction, and
the converting unit generates the third image by converting the resolution of the input image having undergone the inverse gamma correction into the first resolution.

10. The apparatus according to claim 4, wherein the obtaining unit reduces the resolution by generating, from a plurality of pixels of the input image, a pixel whose pixel value falls within a range from a minimum value (inclusive) to an average value (inclusive).

11. The apparatus according to claim 4, wherein the obtaining unit reduces the resolution by generating, from a plurality of pixels of the input image, a pixel whose pixel value is an average value.

12. The apparatus according to claim 4, wherein the obtaining unit reduces the resolution by generating, from a plurality of pixels of the input image, a pixel whose pixel value is a value smaller than an average value.

13. The apparatus according to claim 4, wherein the obtaining unit reduces the resolution by generating, from a plurality of pixels of the input image, a pixel whose pixel value is a median or a value smaller than the median.

14. The apparatus according to claim 4, wherein the obtaining unit reduces the resolution by generating a pixel whose pixel value is obtained by averaging pixel values calculated in a gamma space for a plurality of pixels of the input image.

15. The apparatus according to claim 9, wherein the obtaining unit increases the resolution of the input image by super-resolution technology.

16. The apparatus according to claim 4, further comprising a second gamma correction unit configured to perform gamma correction for the second image obtained by the obtaining unit,
wherein the output unit outputs the second image having undergone the gamma correction by the second gamma correction unit.

17. The apparatus according to claim 1, wherein a pixel count of the first image is larger than a pixel count of the second image.

18. The apparatus according to claim 1, wherein a pixel count of the third image is larger than a pixel count of the second image.

19. A control method for a display control apparatus for controlling stack projection by a plurality of projection apparatuses including a first projection apparatus configured to project an image at a first resolution and a second projection apparatus configured to project an image at a second resolution lower than the first resolution, the method comprising:
obtaining a first image obtained by representing a projection target input image at the first resolution and performing inverse gamma conversion and a second image obtained by representing the input image at the second resolution;
converting the second image represented at the second resolution into a third image for which an inverse gamma conversion is performed, for which change in tone of each pixel is the same as in the second image, and for which resolution is represented by the first resolution;
obtaining a corrected image by correcting a pixel value of each pixel of the first image based on a difference between the pixel value of each pixel of the first image and a pixel value of each pixel of the third image;
performing gamma correction for the corrected image; and
outputting the corrected image having undergone the gamma correction and the second image to the first projection apparatus and the second projection apparatus, respectively.

20. A non-transitory computer-readable storage medium storing a program for causing a computer to execute a control method for a display control apparatus for controlling stack projection by a plurality of projection apparatuses including a first projection apparatus configured to project an image at a first resolution and a second projection apparatus configured to project an image at a second resolution lower than the first resolution, the method comprising:
obtaining a first image obtained by representing a projection target input image at the first resolution and performing inverse gamma conversion and a second image obtained by representing the input image at the second resolution;
converting the second image represented at the second resolution into a third image for which an inverse gamma conversion is performed, for which change in tone of each pixel is the same as in the second image, and for which resolution is represented by the first resolution;
obtaining a corrected image by correcting a pixel value of each pixel of the first image based on a difference between the pixel value of each pixel of the first image and a pixel value of each pixel of the third image;
performing gamma correction for the corrected image; and
outputting the corrected image having undergone the gamma correction and the second image to the first projection apparatus and the second projection apparatus, respectively.
